(19) United States
(12) Patent Application Publication
(10) Pub. No.: US 2003/0003910 A1
(43) Pub. Date: Jan. 2, 2003

(54) Network assisted background scanning for mobile stations

(76) Inventor: Kenneth McClure, Irving, TX (US)

Correspondence Address: HARRINGTON & SMITH, LLP, 4 RESEARCH DRIVE, SHELTON, CT, 06484-6212, US

(21) Appl. No.: 09/894,033

(22) Filed: Jun. 28, 2001

(51) Int. Cl. H04Q 7/20

(52) U.S. Cl. 455/435; 455/434; 455/456

(57) ABSTRACT

A method includes determining, at a network operator, a location of a mobile station, determining if the location of the mobile station indicates that the mobile station may gain access to another allowed network operator and, if so, transmitting a message to the mobile station for assisting the mobile station in gaining access to the other, allowed network operator. If the location of the mobile station indicates that the mobile station may not gain access to another allowed network operator, the method further transmits a message to the mobile station for inhibiting background scanning by the mobile station. The message preferably includes information that is descriptive of a frequency on which the mobile station may receive a transmission from the other, allowed network operator.

### TECHNICAL FIELD

These teachings relate generally to methods and apparatus for providing network selection for mobile terminals, such as cellular telephones, and more specifically relates to techniques for performing mobile station background scanning.

### BACKGROUND

Background scanning is used by several network selection algorithms to enable a mobile station to periodically search for another network. The search can be guided by a number of different criteria set by the network operator and/or by the user. As an example, if a user employs network operator #1 to obtain their service, and if the mobile station is powered up in an area where only network operator #2 is available, the mobile station will register with and camp on a channel of network operator #2. However, the mobile station may periodically leave the channel to network operator #2 to search or scan for a channel provided by network operator #1. This type of operation is typically performed as a background task, and hence can be referred to as background scanning.

Background scanning is very different than cell reselection operations. In cell reselection the mobile station typically scans neighbor cells belonging to the currently selected network operator to locate a cell to which it may immediately, or in the future, hand-off to. A list of neighbor cells to be scanned can be provided by the network and transmitted to the mobile station, and the mobile station may report the results of the neighbor cell scanning operation back to the network.

Background scanning, in contradistinction, provides a mechanism for a primary network operator of the mobile station to force the mobile station to a higher priority network when it is camped on a lower priority network.

Background scanning also involves the mobile station temporarily losing service on the currently registered channel, without the knowledge of the network operator, so that the mobile station can re-tune its receiver to scan for another network operator.

There are two primary problems with background scanning as it is currently performed. The first problem results from the mobile station leaving the registered channel to evaluate other channels in its search for a better network. During the period of time that the mobile station is evaluating other channels, it will miss any messages sent by the base station to which the mobile station is registered sends. This means that the mobile station will miss, by example, pages, short message service (SMS) messages and authentication during background scanning. The second problem results from the periodicity of the background scanning. Since the mobile station will periodically search for better networks while it would normally be camped with its transmitter, digital signal processor (DSP) and central processor unit (CPU) powered down in a sleep mode, the background scanning results in a reduction in battery life. Therefore, it is desirable to reduce the number of background scans that the mobile station perform without locating a better network. This problem is further aggravated by the fact that in some areas there is no better network available. As such, the power consuming background scanning operations will fail to find better service.

If the severity of this problem is reduced by simply increasing the time between background scans, the mobile station is required to reside on a low priority network for a longer period of time. A problem with this situation is that it is possible for the mobile station to camp on a network that does not allow it to receive calls, or that does not allow the mobile station access to desired services.

Thus, in these situations it is imperative that the background scans occur frequently in order to reduce the period without service.

Currently, the decision to enable background scanning is made in the mobile station based upon network identification parameters. Therefore, for time division, multiple access (TDMA) networks, the decision to perform a background scan is based on the System Identifier Code (SID) and the System Operator Code (SOC). These parameters can provide the mobile station with enough information to determine which market (network operator) the mobile station is currently camped on. For example, the mobile station can determine that it is currently located in some metropolitan area. Therefore, if a situation exits where, within the overall metropolitan area, there is one small area (perhaps a border with another market area) that has a higher priority network, the background scanning will be performed within the entire metropolitan area.

The decision to enable background scanning for GSM-type networks is based on the Public Land Mobile Network (PLMN), which gives the identification of the operator and the country. This means that, if a situation exists where, within the United States, there is one small area (perhaps a border with another market area) that has a higher priority, background scanning will be performed in the entire United States. In many cases, forcing background scanning on such a broad scale will result in a very high percentage of unproductive background scans.

The mobile station might possibly add location area parameters to its local database to provide finer granularity, but the resulting database would be several orders of magnitude larger than the current database. Furthermore, these finer location parameters would be controlled only within the operator's business area. Therefore, these location area parameters could change at any time. If these parameters are stored within the mobile station's database, the operator would be required to update the database of every mobile station each time the location parameters changed. With such a large required database, there would be a resulting very large amount of bandwidth utilized for just providing the frequent database updates.

### SUMMARY

The foregoing and other problems are overcome by methods and apparatus in accordance with embodiments of these teachings.

A method is disclosed for operating a wireless communication system, as is a wireless communications system that is constructed in order to implement the method, as well as a mobile station that operates in accordance with the method. The method includes determining, at a network operator, a location of the mobile station, determining if the location of the mobile station indicates that the mobile station may gain access to another allowed network operator and, if so, transmitting a message to the mobile station for assisting the mobile station in gaining access to the other, allowed network operator. If the location of the mobile station indicates that the mobile station may not gain access to another allowed network operator, the method further transmits a message to the mobile station for inhibiting background scanning by the mobile station. The message preferably includes information that is descriptive of a frequency on which the mobile station may receive a transmission from the other, allowed network operator.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is block diagram of a wireless communication system that is suitable for practicing these teachings;

FIG. 2 is depiction of two network operator coverage areas that overlap, and is useful in understanding an example of these teachings; and

FIG. 3 is a logic flow diagram that is descriptive of a method in accordance with these teachings.

### DETAILED DESCRIPTION OF THE PREFERRED EMBODIMENTS

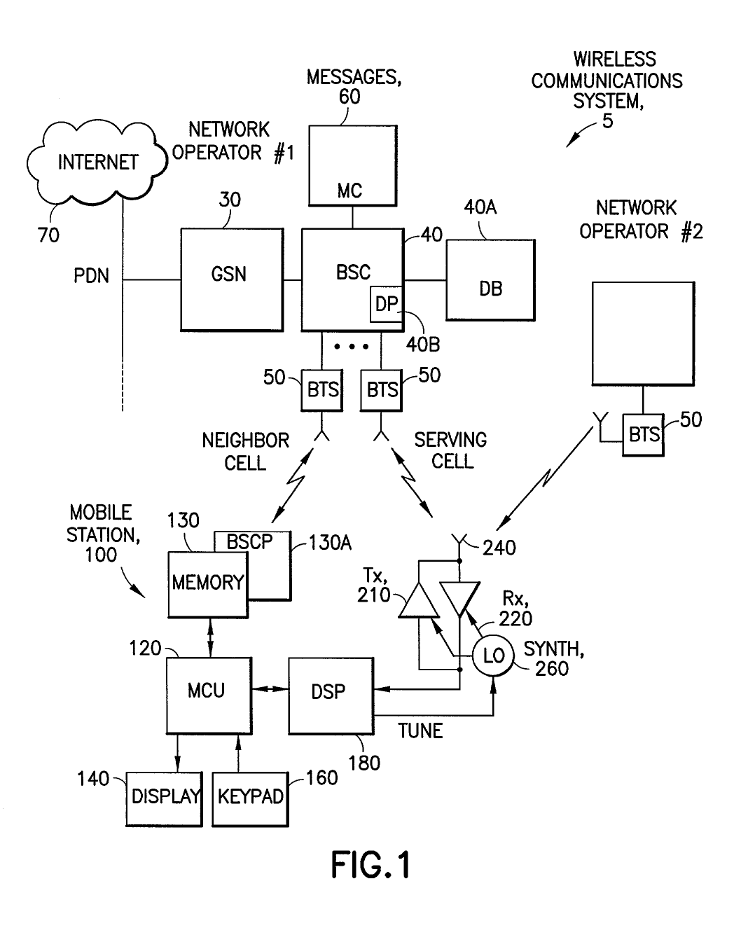

Referring first to FIG. 1, there is illustrated a simplified block diagram of an embodiment of a wireless communications system 5 that is suitable for practicing this invention. The wireless communications system 5 includes at least one mobile station (MS) 100. FIG. 1 also shows an exemplary first network operator (network operator #1) having, for example, a GPRS Support Node (GSN) 30 for connecting to a telecommunications network, such as a Public Packet Data Network or PDN, at least one base station controller (BSC) 40, and a plurality of base transceiver stations (BTS) 50 that transmit in a forward or downlink direction both physical and logical channels to the mobile station 100 in accordance with a predetermined air interface standard. In general, one BTS 50 will provide a serving cell for the mobile station 100, and one or more other BTS 50 will service a neighboring cell or cells. A reverse or uplink communication path also exists from the mobile station 100 to the network operator, which conveys mobile originated access requests and traffic. In an idle mode, the mobile station will be camped on a channel of the BTS 50 of the serving cell.

In a preferred, but not limiting, embodiment of these teachings, the air interface standard can conform to any standard that enables voice and/or data transmissions to occur to the mobile station 100, such as data transmissions enabling Internet 70 access and web page downloads. In one embodiment of this invention the air interface standard is a Time Division Multiple Access (TDMA) air interface that supports a GSM or an advanced GSM protocol and air interface, although these teachings are not intended to be limited to TDMA or to GSM or GSM-related wireless systems.

The first network operator may also include a Message Center (MC) 60 that receives and forwards messages for the mobile stations 100. Other types of messaging service may include Supplementary Data Services and one under currently development and known as Multimedia Messaging Service (MMS), wherein image messages, video messages, audio messages, text messages, executables and the like, and combinations thereof, can be transferred between the network and the mobile station 100.

Service from a second network operator (network operator #2) may also be present in the geographical area that contains the mobile station 100, and the second network operator may or may not be a higher priority network operator than network operator #1. The network operator #2 mat provide the same, more, or fewer services than network operator #1.

The mobile station 100 typically includes a data processor such as a microcontrol unit (MCU) 120 having an output coupled to an input of a display 140 and an input coupled to an output of a keyboard or keypad 160. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer, or even a computer that is wearable by the user.

The MCU 120 is assumed to include or be coupled to some type of a memory 130, including a read-only memory (ROM) for storing an operating program, as well as a random access memory (RAM) for temporarily storing required data, scratchpad memory, received data, data to be transmitted and the like. A separate, removable SIM (not shown) can be provided as well, the SIM storing, for example, a preferred Public Land Mobile Network (PLMN) list and other subscriber-related information. The ROM is assumed, for the purposes of this invention, to store a program enabling the MCU 120 to execute the software routines, layers and protocols required to perform background scanning in accordance with these teachings, as well as to provide a suitable user interface (UI), via display 140 and keypad 160, with a user. Although not shown, a microphone and speaker are typically provided for enabling the user to conduct voice calls in a conventional manner.

The mobile station 100 also contains a wireless section that includes a digital signal processor (DSP) 180, or equivalent high speed processor, as well as a wireless transceiver that includes a transmitter 200 and a receiver 220, both of which are coupled to an antenna 240 for communication with the network operator. At least one local oscillator (LO) 260, such as a frequency synthesizer, is provided for tuning the transceiver. Data, such as digitized voice data and/or packet data, is transmitted and received through the antenna 240. The mobile station 100 also receives certain network-related data from the network operator, including network operator originated data, in accordance with these teachings, that provides the improved mobile station background scanning function.

These teachings enable the network operator, such as the network operator #1 in FIG. 1, to provide direct guidance in background scanning decisions that is specific to the current area that the mobile station 100 is located in. Since the area serviced by a base station, such as the serving BTS 50, is known to the network operator #1, this enhanced position information is used to determine whether the mobile station 100 is on the network that has the best roaming agreement in that area. If the mobile station 100 is on the best network that is available to it in that area, the network operator #1 is enabled to send a message to the mobile station 100 that directs the mobile station 100 to disable background scanning while in this area. The definition of the area may be based on the location area parameter, a SID, SOC and/or digital verification color code (dvcc), or on some other combination of parameters, including the PLMN. If the mobile station 100 is located within an area where it can select a better network (based at least in part upon the network operator's business arrangements with other network operators, such as roaming agreements), the network operator #1 sends a message to the mobile station 100 to enable or even expedite background scanning. Furthermore, the network operator #1 may determine which frequency band, or possibly a channel number, that the mobile station 100 would most likely find the better service, and transmits this information as well. This information may be referred to as background scanning control parameters (BSCP), and it is received by the mobile station 100 and stored in the memory 130 in a BSCP block 130A, as is shown in FIG. 1.

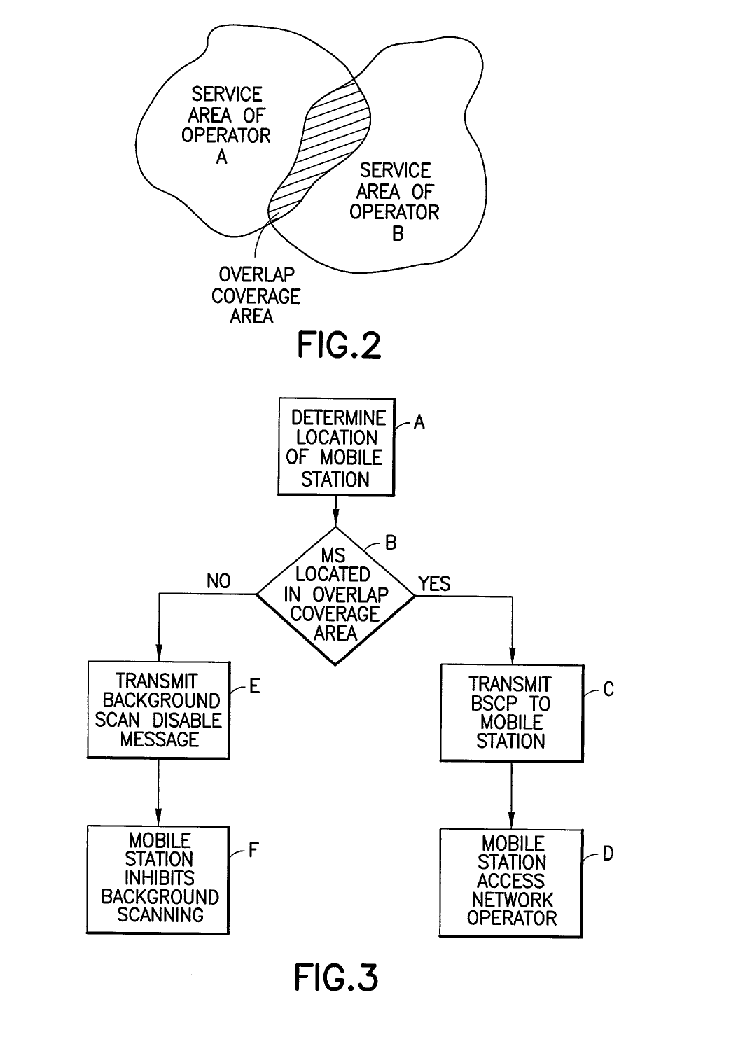

An example is now provided of these network assisted background scanning teachings. Referring to FIG. 2, assume that there are two network operators, such as the network operators #1 and #2 of FIG. 1, who have mutual roaming agreements. Assume further that there are areas where these network operators are not in competition with each other (areas where there is no overlap in coverage) and at least one area where these network operators are in competition with each other (in an area where there is coverage overlap).

If the mobile station 100 has Operator B as its primary service provider, Operator B will wish to ensure that the mobile station 100 is using Operator B's network whenever possible, and is only using Operator A's network when there is no Operator B service available.

With current methods for determining when to perform background scanning, there are two behaviors that Operator B can dictate for the mobile station 100 when the mobile station 100 is in the coverage area of Operator A. Operator B can set up the mobile station 100 database to force the mobile station 100 to do one of the following things when camped upon Operator A's network:

1) Remain camped upon Operator A's network and do not look for a higher priority network.

2) Remain camped upon Operator A's network, but perform background scanning to attempt to locate a higher priority network.

However, there are problems associated with both of these directives. The problem with directive 1 is that, if the mobile station 100 happens to select Operator A's network in the area where both Operator A and Operator B provide service, the mobile station 100 will not transition to Operator B's network. This clearly would violate Operator B's network selection intent. The problem with directive 2 is that, if the mobile station 100 is in area A where there is no Operator B network present, the mobile station 100 will continually perform background scanning when there is no chance of finding a higher priority system. Although Operator B's network selection intent is preserved in this scenario, the mobile station 100 still suffers from all of the drawbacks of background scanning, e.g., increased probability of missing pages and other messages, as well as increased power consumption, while having no chance of successfully locating the higher priority network operator.

These teachings beneficially enable the mobile station's home network to send specific background scanning guidelines to the mobile station 100 when the mobile station 100 is camped on a “friendly” network (friendly implies that there is some agreement in place that allows the mobile station 100 to use the network it is camped upon for service).

Therefore, assuming that the mobile station 100 is given directive 1, Operator A's network may send a message to the mobile station 100 when the mobile station 100 is camped on Operator A's network in the overlap area where both Operator A and Operator B have coverage. This message may contain an order to perform background scanning to find Operator B's network. Furthermore, this message may contain information to instruct the mobile station 100 as to exactly which license block (i.e., set of frequencies, such as those in the 800 MHz or the 1900 MHz band), or even which channel number, to search when attempting to locate Operator B's network.

Likewise, assuming that the mobile station 100 is given directive 2, Operator A's network may send a message to the mobile station 100 when the mobile station 100 is camped upon Operator A's network in the area where there is no Operator B network present. This message may contain an order for the mobile station 100 to disable background scanning, thus avoiding the negative aspects of performing background scanning when there is no chance of success.

Based on the foregoing it should be appreciated that these teachings provide a method for the network operator to control background scanning based upon information related to the mobile station, such as the location of the mobile station 100, as well as on relationships that the network operator has with other network operators. These teachings also enable the use of finer mobile station location granularity to determine when the mobile station 100 should perform background scanning, as well as when background scanning should be inhibited. Relatedly, these teachings provide a centralized database (DB 40A) that is used by a network data processor (DP) 40B to determine when to perform background scanning, instead of relying a databases that are distributed among the mobile stations 100 that are supported by the network operator. As such, changes that are made to database 40A do not need to be transmitted to the mobile stations 100, thereby conserving bandwidth, as well as mobile station power.

FIG. 3 is a logic flow diagram that is exemplary of these teachings. At Block A the currently serving network operator determines the location of the mobile station 100. The location information can be derived from the location of the BTS 50 that is presently serving the mobile station 100, or even finer location information can be obtained such as by triangulating the mobile station's location using multiple BTSs 50, and/or by using time alignment data, or by any suitable technique. It is also within the scope of these teachings to query the mobile station 100 to send its position, which could be derived from Global Satellite Positioning (GPS) data, or from the mobile station user entering position-related information (e.g., corner of Main Street and Elm Street).

At Block B the network operator accesses the database 40A and, in accordance with the determined location of the mobile station 100, make a further determination if the mobile station 100 is located in the service area of another network operator with which the serving network operator has a satisfactory business relationship (e.g., a roaming agreement). That is, a determination is made if the mobile station 100 is located in the overlap coverage area with an acceptable system operator, as shown in FIG. 2. If this is the case, the serving network operator transmits at Block C a message or messages to the mobile station 100 for informing the mobile station of the background scanning control parameters 130A corresponding to the current location of the mobile station 100. As was discussed above, the background scanning control parameters 130A may include a range of channels, or a specific channel and/or any other information that would aid the mobile station 100 in locating the other network operator. In response, the mobile station 100, at Block D, retunes its receiver 220 to attempt to access the other network operator, and eventually may gain service from the other network operator.

If a check of the database 40A at Block B does not find that the mobile station 100 is located where service can be obtained from an acceptable network operator, or if no other network operator is available, then the serving network operator transmits at Block E a message or messages to the mobile station 100 for disabling the background scanning function. In response, at Block F the mobile station 100 inhibits background scanning.

While these teachings have been particularly shown and described with respect to preferred embodiments thereof, it will be understood by those skilled in the art that changes in form and details may be made therein without departing from the scope and spirit of these teachings.

What is claimed is:

1. A method for operating a wireless communication system, comprising:
determining, at a network operator, a location of a mobile station;
determining if the location of the mobile station indicates that the mobile station may gain access to another allowed network operator; and
if so, transmitting a message to the mobile station for assisting the mobile station in gaining access to the other, allowed network operator.

2. A method as in claim 1, wherein if the location of the mobile station indicates that the mobile station may not gain access to another allowed network operator, transmitting a message to the mobile station for inhibiting background scanning by the mobile station.

3. A method as in claim 1, wherein the message comprises information descriptive of a frequency on which the mobile station may receive a transmission from the other, allowed network operator.

4. A wireless communication system comprising at least one network operator and at least one mobile station located in a service area of said network operator, and further comprising a network operator data processor for determining a location of a mobile station and a database that is accessed by the data processor for determining if the location of the mobile station indicates that the mobile station may gain access to another, allowed network operator, said data processor being responsive to a determination that the mobile station may gain access to another allowed network operator for transmitting a message to the mobile station for assisting the mobile station in gaining access to the other, allowed network operator.

5. A wireless communication system as in claim 4, wherein if the location of the mobile station indicates that the mobile station may not gain access to another allowed network operator, said data processor transmitting a message to the mobile station for inhibiting background scanning by the mobile station.

6. A wireless communication system as in claim 4, wherein the message comprises information descriptive of a frequency on which the mobile station may receive a transmission from the other, allowed network operator.

7. A mobile station comprising a RF transceiver, a data processor and a memory, said data processor being responsive to a message received through said transceiver from a network operator that is currently serving said mobile station for storing information into said memory, said data processor being responsive to said stored information for one of inhibiting background scanning for another network operator, or for attempting to access another network operator in accordance with the stored information.

8. A mobile station as in claim 7, wherein in one case the message comprises information descriptive of a frequency on which the mobile station may receive a transmission from the other network operator.
